(19) United States
(12) Patent Application Publication
(10) Pub. No.: US 2011/0250009 A1
(43) Pub. Date: Oct. 13, 2011

(54) Method and Apparatus for Reconfigurable Furniture

(76) Inventor: Loren Swanson, San Francisco, CA (US)

(21) Appl. No.: 12/756,808

(22) Filed: Apr. 8, 2010

(51) Int. Cl. F16D 1/00; B23P 17/04

(52) U.S. Cl. 403/24; 29/428

(57) ABSTRACT

An apparatus for reconfigurable furniture includes a link assembly. The link assembly includes a plurality of link plates each including at least two parallel flat surfaces and at least one hole extending through the flat surfaces. A connecting rod extends through holes on the flat surfaces providing an axis of rotation for the link plates. Two end caps are joined to ends of the connecting rod where the end caps are operable to create a tension force along the connecting rod to provide a degree of rotational resistance between flat surfaces of the link plates. Means joins at least two link assemblies, wherein positions of the link plates are reconfigurable to form the furniture.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to furniture design and manufacture. More particularly, the invention relates to articulated furniture having pieces designed to move, and most particularly to furniture having articulated pieces that may be moved and reconfigured or rearranged to suit the needs of the user.

### BACKGROUND OF THE INVENTION

Furniture has been made in many ways over the centuries. Yet even today typical furniture designs possess several limiting factors.

Single Form and Function

Most furniture today is difficult if not impossible to change from its original function or style, and there is little or no transformation possible. A typical chair purchased today will always retain the particular form and function of a chair and cannot be reconfigured to suit a different idea, need or purpose.

Labor Intensive

Furniture has typically been labor intensive to assemble and most of this assembly is performed at a factory by skilled laborers with special tools. This labor-intensive assembly increases the final cost of traditional furniture designs.

Increased Distribution Shipping Sizes

In addition to the labor costs associated with factory assembly, this production process can also dramatically increase the size of the final product. A typical furniture assembly is usually composed of large nearly monolithic parts that require large trucks and warehouses to deliver and store. This added sized can add tens or hundreds of dollars to the cost of the furniture and the overhead associated with distribution and sale.

Repair Difficulties

After the furniture has been manufactured, transported, stored, and finally sold there is still another issue that may arise. If something breaks or needs to be replaced, it is usually impractical to ship the furniture back to the manufacturer for repairs. Instead, furniture owners must typically rely on locally available trades persons skilled in the repair of furniture. Ultimately the skilled labor with special tools as well the time and transportation can add tens or hundreds of dollars to the total cost of owning furniture.

In view of the foregoing, there is a need for improved techniques for providing furniture that is versatile and easy to ship, store, assemble and repair.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exploded view of an exemplary link assembly from a biomorphic furniture system, in accordance with an embodiment of the present invention;

FIG. 2 illustrates exemplary link assemblies from a biomorphic furniture system, in accordance with an embodiment of the present invention;

FIG. 3 illustrates many exemplary variations of link plates that may be used in a biomorphic furniture system, in accordance with an embodiment of the present invention;

FIG. 4 illustrates a standard end cap for a biometric furniture system, in accordance with an embodiment of the present invention;

FIG. 5 illustrates an exemplary end cap that has an integrated quick release mechanism, in accordance with an embodiment of the present invention. FIG. 5a shows a rear isometric view of the end cap with the quick release mechanism in a closed or tight position. FIG. 5b shows a frontal isometric view with the quick release mechanism in the closed or tight position, and FIG. 5c shows an exploded frontal isometric view with the quick release mechanism in an open or loose position;

FIG. 6 illustrates an exemplary torque-resisting disk, in accordance with an embodiment of the present invention;

FIG. 7 illustrates an exemplary torque disk with radial ridges, in accordance with an embodiment of the present invention;

FIG. 8 illustrates an exemplary link plate with sheer holes, in accordance with an embodiment of the present invention;

FIG. 9 illustrates an exemplary link plate with sheer holes and a torque disk with radial ridges, in accordance with an embodiment of the present invention

FIG. 10 illustrates an exemplary multi-axis joint assembly with two axes of rotation, in accordance with an embodiment of the present invention;

FIGS. 11a through 11f illustrate exemplary perpendicular joint assemblies, in accordance with an embodiment of the present invention. FIGS. 11a and 11b show two multi-axis joint assemblies each with two axes of rotation and one link joint around a central axis. FIG. 11c shows a multi axis joint assembly with two axes of rotation and two link joints around a central axis. FIG. 11d shows a multi axis joint assembly with two axes of rotation and three link joints around a central axis. FIG. 11e shows a multi axis joint assembly with two axes of rotation and four link joints around a central axis. FIG. 11f shows a multi axis joint assembly with two axes of rotation and six link joints around a central axis;

FIG. 12 illustrates an exemplary table assembled using a biomorphic furniture system, in accordance with an embodiment of the present invention;

FIGS. 13a through 13d illustrate an exemplary lounge chair assembled using a biomorphic furniture system, in accordance with an embodiment of the present invention. FIG. 13a illustrates exemplary surface sleeves. FIG. 13b illustrates an exemplary chair frame. FIG. 13 c illustrates the assembled chair in a horizontal position, and FIG. 13d illustrates the assembled chair in an upright position;

FIG. 14 illustrates an exemplary cantilevered chair assembled using a biomorphic furniture system, in accordance with an embodiment of the present invention;

FIG. 15 illustrates an exemplary desk and chair assembled using a biomorphic furniture system, in accordance with an embodiment of the present invention;

FIGS. 16a and 16b illustrate an exemplary chair configuration that has a humanoid form assembled using a biomorphic furniture system, in accordance with an embodiment of the present invention. FIG. 16a shows the chair structure without cushions, and FIG. 16b show the chair structure with cushions;

FIG. 17 illustrates an exemplary bed with four post type arms assembled using a biomorphic furniture system, in accordance with an embodiment of the present invention;

FIGS. 18a and 18b illustrate an exemplary nightstand incorporating a storage pod unit assembled using a biomorphic furniture system, in accordance with an embodiment of the present invention. FIG. 18a illustrates the nightstand, and FIG. 18b illustrates storage pod unit separate from the nightstand;

FIG. 19 illustrates an exemplary armoire that comprises a storage pod unit assembled using a biomorphic furniture system, in accordance with an embodiment of the present invention; and

FIG. 20 illustrates an exemplary humanoid figure assembled using a biomorphic furniture system, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a method and apparatus for reconfigurable furniture is presented.

In one embodiment, an apparatus for reconfigurable furniture is presented. The apparatus includes a link assembly. The link assembly includes a plurality of link plates each including at least two parallel flat surfaces and at least one hole extending through the flat surfaces. A connecting rod extends through holes on the flat surfaces providing an axis of rotation for the link plates. Two end caps are joined to ends of the connecting rod where the end caps are operable to create a tension force along the connecting rod to provide a degree of rotational resistance between flat surfaces of the link plates. Means joins at least two link assemblies, wherein positions of the link plates are reconfigurable to form the furniture. Another embodiment further includes at least one torque disk including a central hole and, the torque disk being positioned on the connecting rod to further provide rotational resistance. In further embodiments the torque disk further includes at least one surface including frictional properties to provide rotational resistance and the frictional properties includes radial ridges. In yet another embodiment the torque disk further includes nubs to engage corresponding holes on a one of the link plates. In yet another embodiment at least one of the end caps includes a quick release mechanism for engaging and releasing the tension force. In still another embodiment at least two of the link plates includes a plurality sheer holes in the flat surfaces and the apparatus further includes a pin or rod inserted between adjacent sheer holes of the at least two link plates. Other embodiments further include a link tube positioned between adjacent link plates and a surface sleeve covering the link tube. Another embodiment further includes a storage pod joinable between adjacent link plates. In yet another embodiment a plurality link assemblies are joined with a flat surface to be configured as a table.

In another embodiment an apparatus for reconfigurable furniture is presented. The apparatus includes a link assembly having means for joining a plurality of link plates on an axis of rotation of the link plates and means for creating a tension force along the means for joining a plurality of link plates to provide a degree of rotational resistance the link plates. Means joins at least two link assemblies, wherein positions of the link plates are reconfigurable. Another embodiment further includes means for increasing rotational resistance between adjacent link plates. Yet another embodiment further includes means for joining a storage unit.

In another embodiment a method for reconfiguring furniture is presented. The method includes steps for joining a plurality of link plates on a plurality of connecting rods, joining end caps to ends of the connecting rods to provide a degree of rotational resistance between the link plates and form link assemblies and joining the link assemblies in a reconfigurable manner to form the furniture. Another embodiment further includes a step of joining at least one torque disk on at least one connecting rod to further provide rotational resistance. Yet another embodiment further includes a step of joining a link tube to one of the link assemblies. Another embodiment further includes a step of joining a surface sleeve to the link tube. Still another embodiment further includes a step of joining a storage pod to one of the link assemblies. Another embodiment further includes a step of joining a flat surface to the link assemblies.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Description of Biomorphic Furniture System

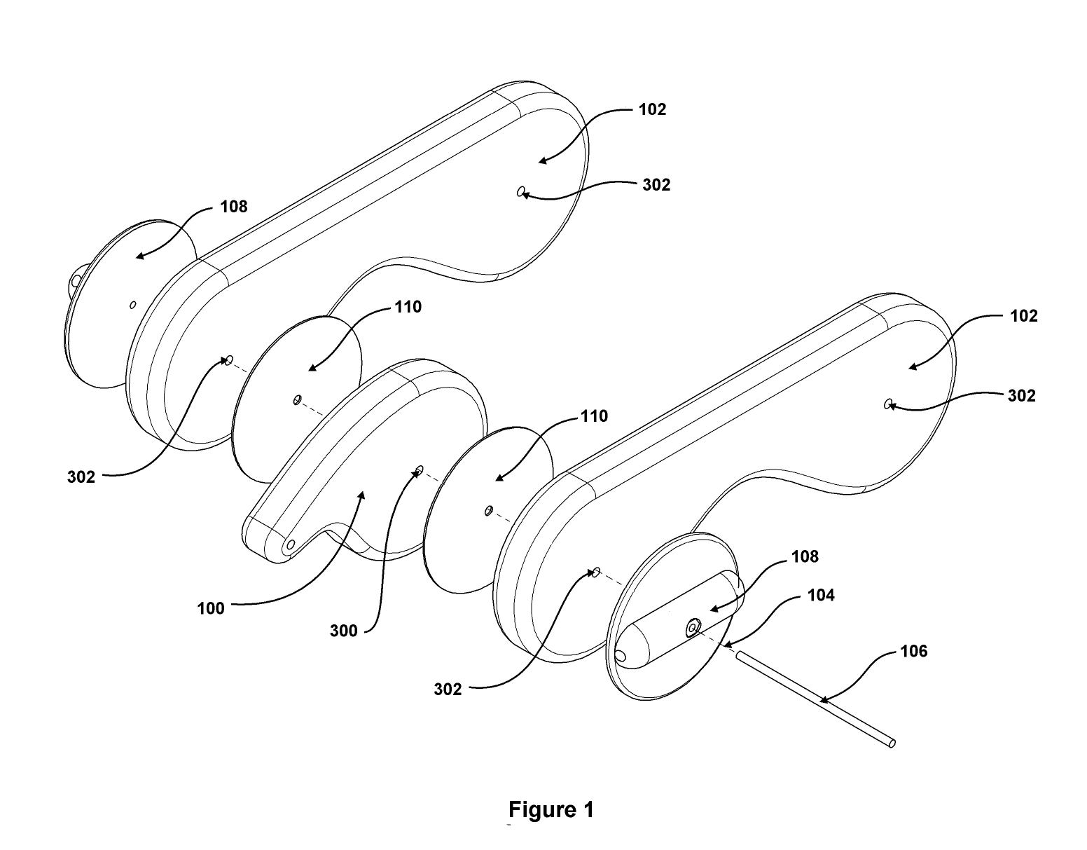

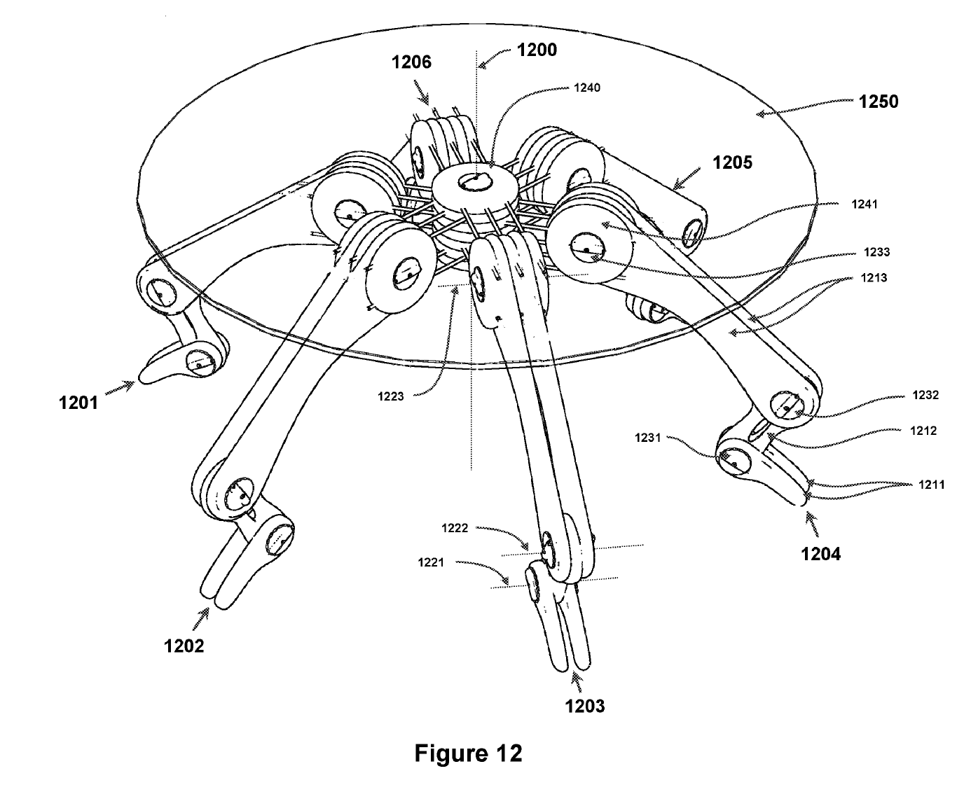

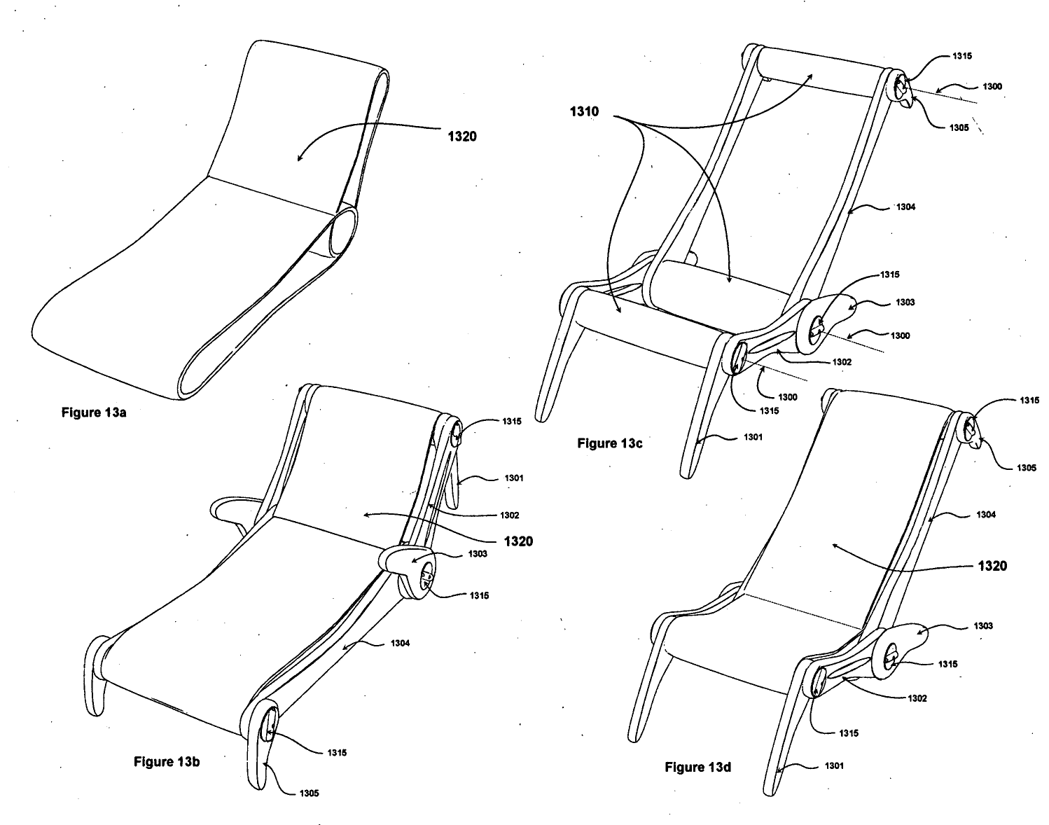

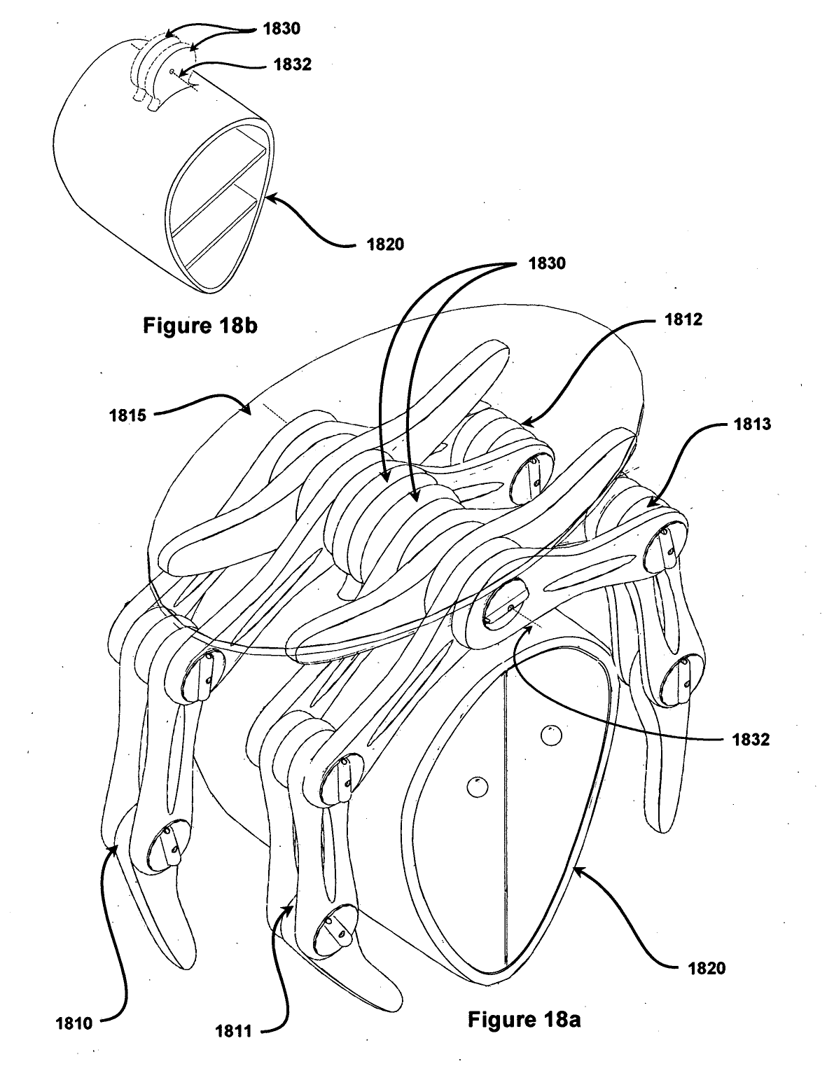

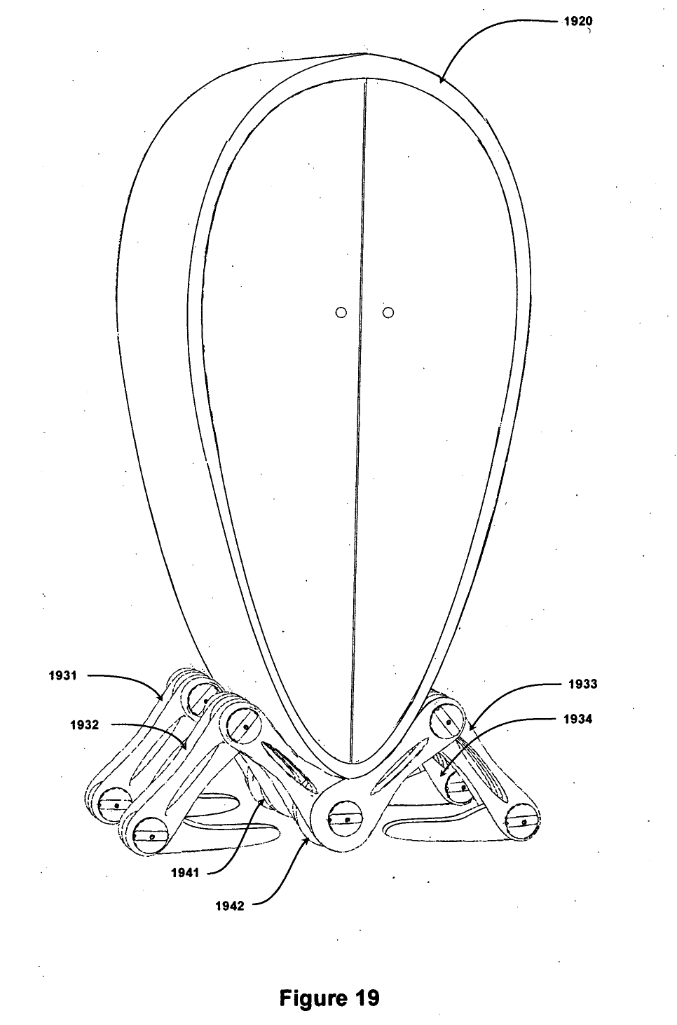

A preferred embodiment of the present invention provides a biomorphic furniture system that encompasses the components and assemblies that make up the building blocks for furniture inspired by biological shapes and mechanisms. The components in preferred embodiments may be reconfigured and moved to create a nearly infinite number of combinations and forms. A basic unit of a biomorphic furniture system in a preferred embodiment comprises at least two, though usually several, link assemblies joined together to create a variety of furniture types and uses. An exemplary link assembly is illustrated by way of example in FIG. 1, and a variety of exemplary furniture pieces are illustrated by way of example in FIGS. 12 through 19. In addition to the basic structural components, a piece of furniture may also comprise additional elements such as, but not limited to, elements that facilitate storage as shown by way of example in FIGS. 18a, 18b and 19, sitting surfaces as shown by way of example in FIGS. 13 through 16, hard flat surfaces for holding objects as shown by way of example in FIGS. 12, 15 and 18a, etc.

A biomorphic furniture system according to preferred embodiments is unique in its ability to transform, change and grow as the needs of the user may dictate. Preferred embodiments comprise simple and easy to mass produce parts that can be assembled, adjusted, rearranged, replaced and therefore modified and repaired by the end user.

Biomorphic furniture systems according to preferred embodiments allow for multiple reuses of parts in various configurations in contrast to a large static or single use piece of furniture. The parts in preferred embodiments can be reconfigured and adjusted into different furniture configurations and uses, for example, without limitation, a table may be converted into a chair or a small narrow table may be converted into a wide large table by changing the arrangements of the pieces. The user can assemble, repair, restyle and reconfigure preferred embodiments to suit their needs.

The modular approach of preferred embodiments also makes it easier to store, repair and ship furniture while simultaneously minimizing the cost by reducing much of the labor and distribution problems. Depending on the number of components included, the assembly can also be packaged in a smaller container than conventional furniture.

Descriptions of Components

Link Assembly

FIG. 1 illustrates an exploded view of an exemplary link assembly from a biomorphic furniture system, in accordance with an embodiment of the present invention. The link assembly acts as the primary shape and structure of furniture constructed with a biomorphic furniture system and enables the adjustment and rotational movement of the adjoining links. In the present embodiment, the link assembly comprises four basic types of components; link plates 100 and 102, a connecting rod 106, end caps 108, and optional torque-resisting disks 110. In alternate embodiments, link assemblies may comprise various different combinations of these components. For example, without limitation, alternate embodiments may comprise more or fewer link plates, and some embodiments may not comprise torque-resisting disks.

In the present embodiment, link plates 100 and 102 share a common axis of rotation 104 on which adjacent members may be rotated. Connecting rod 106 provides a means for joining the link plates on the axis. Connecting rod 106 runs thru this axis of rotation 104, and end caps 108 are placed on either end of connecting rod 106. The link assembly may be rendered immovable or rotationally resisted to various degrees by tightening end caps 108 and creating a tension force along connecting rod 106. Thus, end caps 108 provide a means for creating the tension force. This tension causes a compression and frictional force between the adjacent intersecting faces of link plates 100 and 102 and torque disks 110. The frictional force can be further augmented through the use of various torque-resisting devices such as, but not limited to, torque resisting disks 110, sheer rods, ratcheting devices or adhesives, and techniques such as, but not limited to, using frictional force or using sheer force or a ratcheting mechanism.

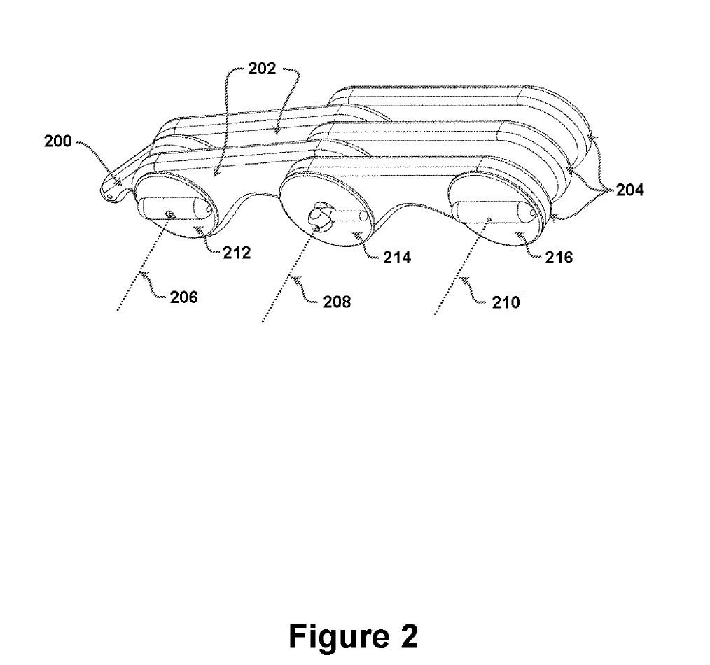

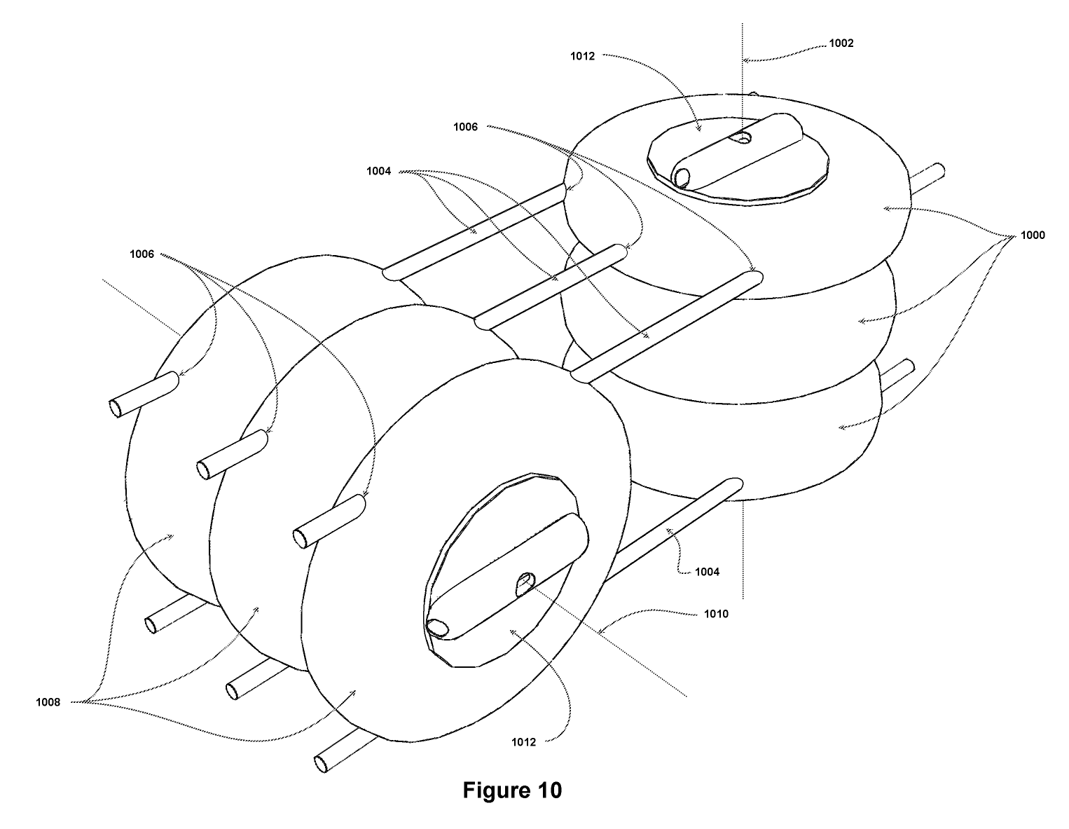

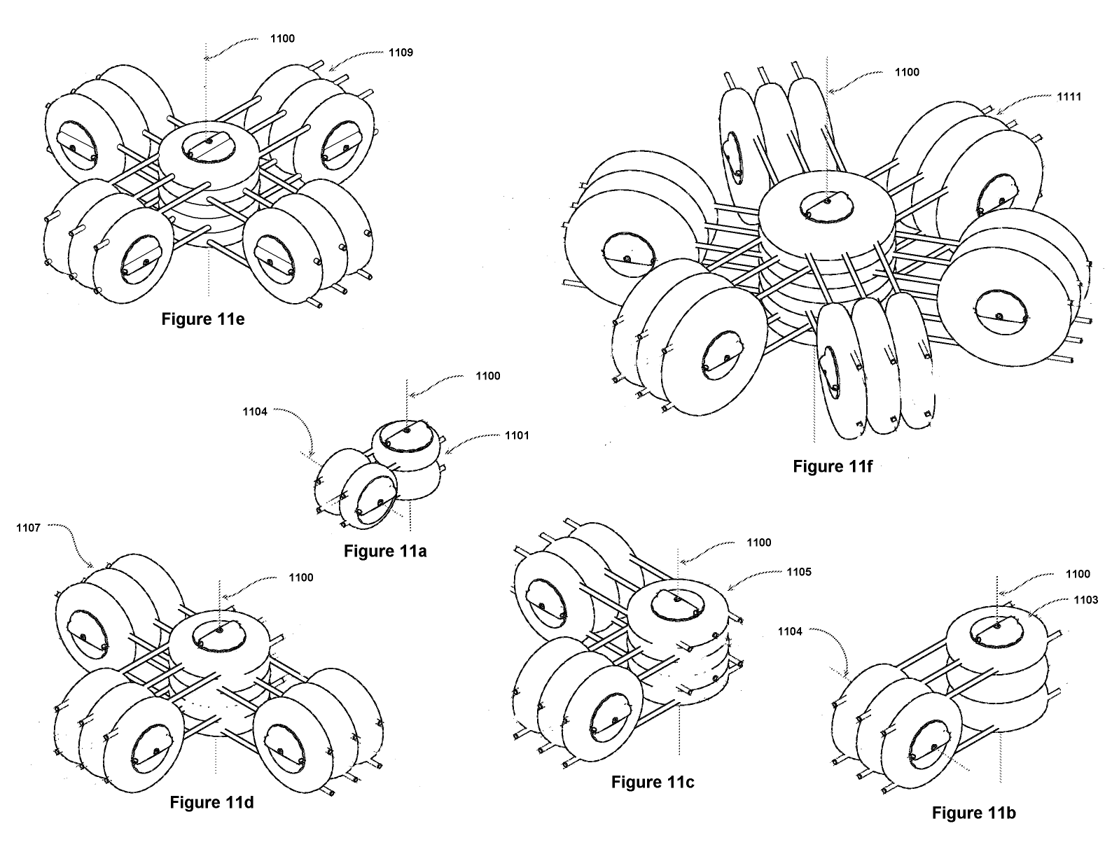

FIG. 2 illustrates exemplary link assemblies from a biomorphic furniture system, in accordance with an embodiment of the present invention. In the present embodiment, the link assemblies comprise three link plates 204 that share a common axis of rotation 208 with two link plates 202 that share a common axis of rotation 206 with a single link plate 200. In this embodiment the common axis provides a means to join individual link assemblies. In other embodiments connecting rods between link plates provides a means for joining individual link assemblies, as shown in FIGS. 10 and 11. In this embodiment, the link plates that share a common axis of rotation are held in place and rotationally resisted by tightening end caps 212 and 214 on either end of connecting rods that run through common axes of rotation 206 and 208. FIG. 2 also illustrates two exemplary variations of end caps. In the present embodiment, end caps 212 and 216 are standard end caps, while end cap 214 is a quick release type end cap.

In the present embodiment, the link assembly can have additional link plates added around axis of rotation 210. At least two link plates may be placed between the three link plates 204 so that both sets of link plates are disposed around axis of rotation 210 with end caps 216 on either end of a connecting rod (not visible) running through shared axis of rotation 210.

Link assemblies such as, but not limited to, the link assemblies illustrated by way of example in FIGS. 1 and 2 interconnect with similar link assemblies or other link assemblies, such as, but not limited to, the link assemblies illustrated by way of example in FIGS. 10 and 11 to form the primary structural components of a biomorphic furniture system according to a preferred embodiment of the present invention. Those skilled in the art, in light of the present teachings, will readily recognize that link assemblies may comprise various components in various configurations depending on factors such as, but not limited to, the desired function, aesthetic appeal, size requirements, etc. For example, without limitation, a link assembly meant to act as the leg of a table may comprise two or three long link plates, while a link assembly meant to act as an arm of a chair may comprise three or four short link plates.

Link Plates

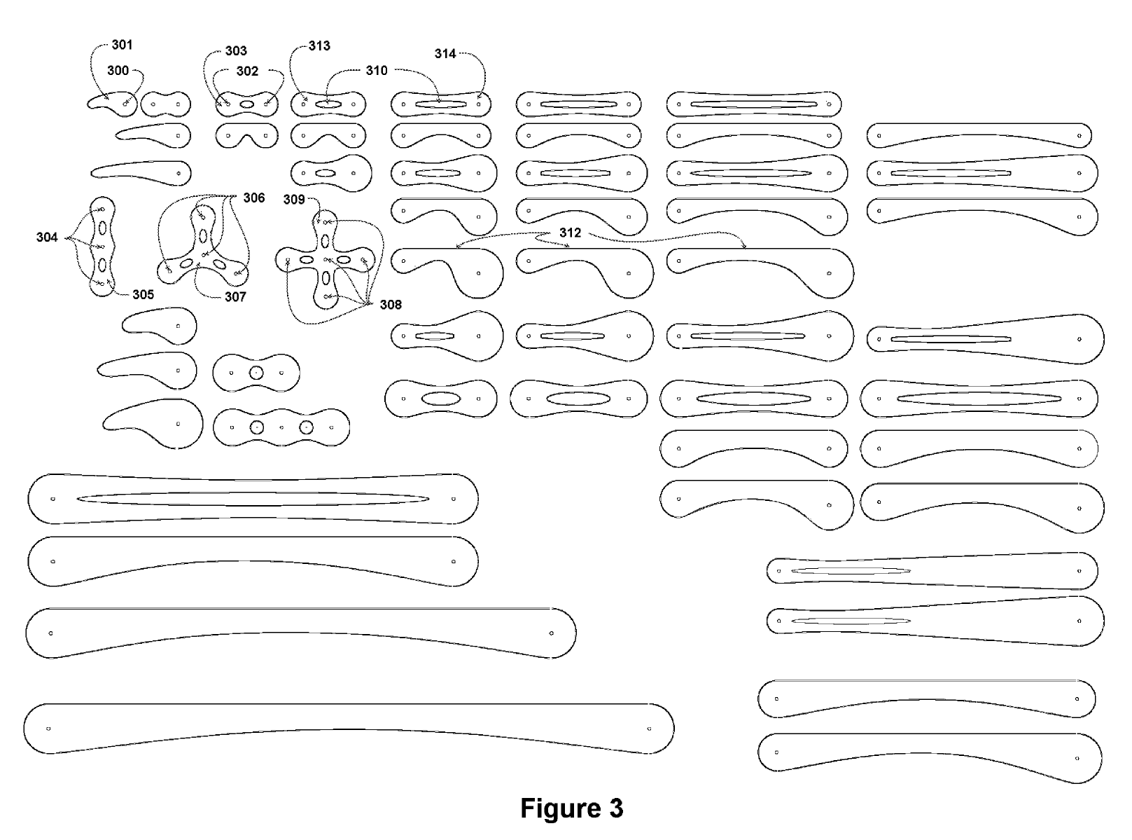

FIG. 3 illustrates many exemplary variations of link plates that may be used in a biomorphic furniture system, in accordance with an embodiment of the present invention. All link plates comprise at least one axis of rotation hole, yet most link plates comprise two axes of rotation holes, and some link plates may have three or more axis of rotation holes. For example, without limitation, a link plate 301 comprises one axis of rotation hole 300, a link plate 303 comprises two axis of rotation holes 302, a link plate 305 comprises three axis of rotation holes 304, a link plate 307 comprises four axis of rotation holes 306, and a link plate 309 comprises five axis of rotation holes 308. The axis of rotation hole or holes are typically perpendicular to the flat surface of the link plate. However, some embodiments may comprise axis of rotation holes that are at an angle to the flat surface of the link plate to create angled link assemblies. Some link plates may have holes or openings between the axis of rotation holes, for example without limitation, openings 310 in link plates 313 and 314. The link plates may also have ends of varying size around the axis of rotation holes to accommodate larger or smaller adjoining link plates. For example, without limitation, link plates 312 comprise a small end around one axis of rotation hole and a larger end around the other axis of rotation hole. As shown by way of example in FIG. 3, link plates may greatly vary in length and may vary in width as well. The link plates are typically of a modular dimension as to limit the number of manufactured pieces required to assemble pieces of furniture. However, link plates may be made in non-modular dimensions in some embodiments.

In the present embodiment, the link plates are typically made of solid wood or plywood although link plates in alternate embodiments, may be made of a variety of other materials including, but not limited to, metal, plastic, acrylic, and foam. Link plates may be quickly and easily machined by an automated computer numerical code (CNC) machine or injection molded if made of plastic. Those skilled in the art, in light of the present teachings, will readily recognize that there is a multiplicity of suitable means for making link plates for various embodiments of the present invention. For example, without limitation, in some embodiments, link plates may be cut with a saw by hand, etc.

Connecting Rod

Referring to FIG. 1, connecting rod 106 is placed thru holes in link plates 100 and 102 and in torque disks 110 along axis of rotation 104. Connecting rod 106 is used to hold link plates 100 and 102 together to form the link assembly. Connecting rod 106 may also allow for the rotation of adjacent link plates 100 and 102 around connecting rod 106. Connecting rod 106 may also resist the tension force that may be applied when end caps 108 are tightened and compressed against adjoining link plates 100 and 102. Connecting rods in various embodiments are available in a variety of modular lengths that may correspond with the number of link plates that the connecting rod must traverses and hold together. In some embodiments, connecting rods may be available in long lengths with divisions etched into the connecting rods so they may be bent and snapped off to facilitate dividing the connecting rods into the necessary shorter lengths. Connecting rods can also provide a means for joining link assemblies. Connecting rods in preferred embodiments are typically threaded metal rods; however, connecting rods in alternate embodiments are not necessarily metal or threaded. For example, without limitation, connecting rods in alternate embodiments may be made of various materials including, but not limited to, wood or plastic.

End Cap

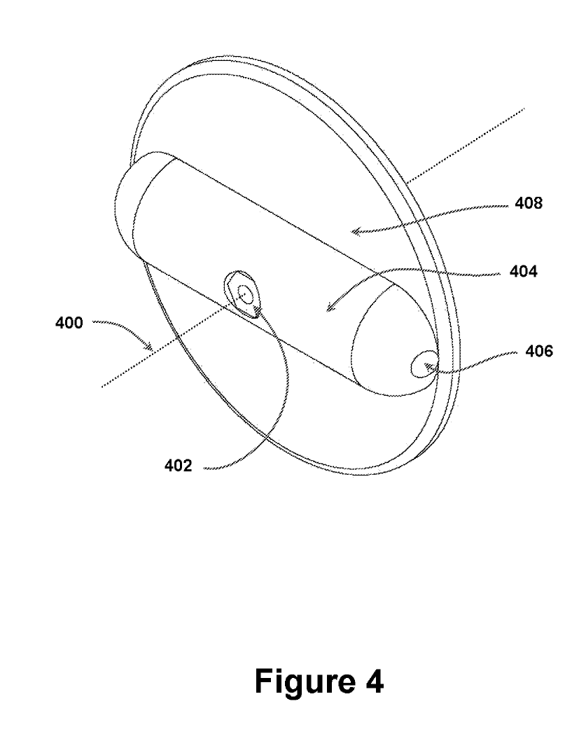

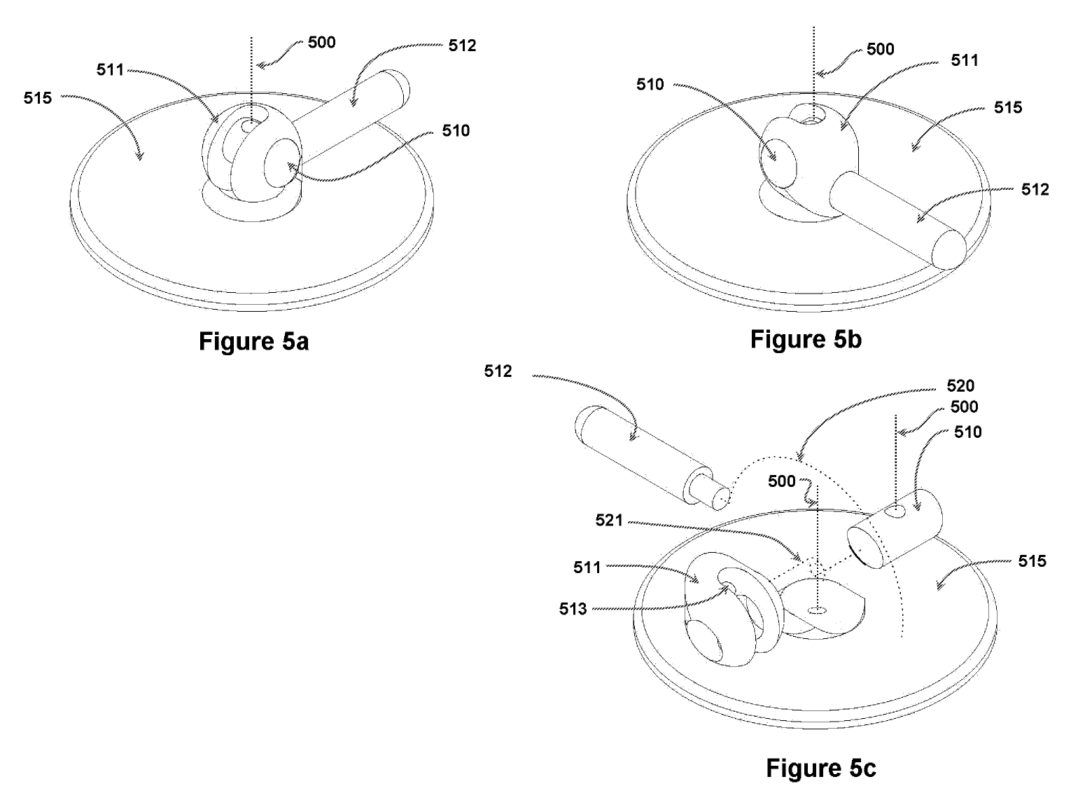

FIG. 4 illustrates a standard end cap for a biometric furniture system, in accordance with an embodiment of the present invention. The end cap illustrated depicts a simple threaded or screw on type of end cap. End caps may be made more elaborate in alternate embodiments by incorporating features such as, but not limited to, a quick release mechanism as shown by way of example in FIG. 5. In the present embodiment, the end cap comprises a hole around an axis of rotation 400 Axis of rotation holes in end caps are typically threaded in some way to enable a connecting rod to thread onto and connect through the end cap. In some embodiments this threading is incorporated into the hole around the axis of rotation. In the present embodiment, the hole around axis of rotation 400 comprises a threaded nut 402 to provide the threads rather than having threads integrated into the end cap piece itself. The standard end cap also comprises a raised surface or bump 404 to enable the user to turn the end cap with their fingers to thread and tighten or loosen the end cap to a connecting rod. However, alternate embodiments may be flat or various other shapes. In the present embodiment, the end cap also comprises a hole or feature 406 into which a rod or extension may be placed to provide greater torque to be generated to tighten or loosen the end cap on a connecting rod. The end cap also incorporates a flat plate 408 that helps distribute the compression force of the end cap to the face of the adjoining link plate. In the present embodiment, flat plate 408 is circular in shape; however, alternate embodiments may comprise flat plates in different shapes such as, but not limited to, various polygons, ovals, irregular shapes, decorative shapes such as, but not limited to, flowers or stars, etc. End caps can be screwed inward, or tightened, along a connecting rod to generate tension in the connecting rod and a compression force in the adjoining faces of the link plates on the connecting rod. The generated compression and friction forces resist the rotation of the adjacent link assemblies and may be uses to fix link assemblies in a static position relative to one another.

FIG. 5 illustrates an exemplary end cap that has an integrated quick release mechanism, in accordance with an embodiment of the present invention. FIG. 5a shows a rear isometric view of the end cap with the quick release mechanism in a closed or tight position. FIG. 5b shows a frontal isometric view with the quick release mechanism in the closed or tight position, and FIG. 5c shows an exploded frontal isometric view with the quick release mechanism in an open or loose position. In the present embodiment, a hole around an axis of rotation 500 is threaded to enable the end cap to be rotationally threaded inward, or tightened, similarly to the standard end cap shown by way of example in FIG. 4. The difference is that the end cap in the present embodiment comprises the quick release mechanism that enables the quick application or removal of the tension on a connecting rod and the compression and frictional forces on link assemblies created by the pressure of the end cap. With the tension released, adjacent link plates are free to rotate with respect to each other about their common axis of rotation.

The quick release mechanism is similar in function and design to a quick release mechanism of a bicycle. However, in the present embodiment, the quick release mechanism comprises a release handle 512 that is removable. This is to generally ensure that the end cap is not easily loosened or accidentally released by bumping release handle 512.

In the present embodiment, the quick release mechanism comprises a pivot pin 510 that fits into a pivot cam 511. One end of release handle 512 fits into a hole 513 in pivot cam 511. A pivot cam axis of rotation 521 is slightly off center so that when pivot cam 511 is rotated around pivot pin 510 along pivot axis of rotation 521, pivot cam 511 rotates and moves an end cap plate 515 up or down along an end cap axis of rotation 500. An arc 520 illustrates the path that release handle 512 travels when the quick release mechanism is operated to loosen or tighten the quick release end cap. In typical use of the present embodiment, the end cap is threaded onto a connecting rod with release handle in the open or loose position. Then release handle is moved along arc 520 to the closed or tight position to place additional tension on the connecting rod. Torque Disks

As end caps in preferred embodiments are threaded onto connecting rods and tightened, the tension force on the connecting rods produces compression and frictional forces between the adjoining link plates. This frictional force resists the rotational force of the link plates about their axes of rotation, thereby rendering the adjoining link plate subunits relatively immobile and static with respect to each other. The compression and frictional forces generated between the link plates is not always adequate to resist the rotational torque forces that may occur on the joints between adjoining link assemblies. Preferred embodiments employ one or both of the following methods to further resist larger rotational forces that may be generated in the link assemblies; a friction method and a sheer method.

Friction Method

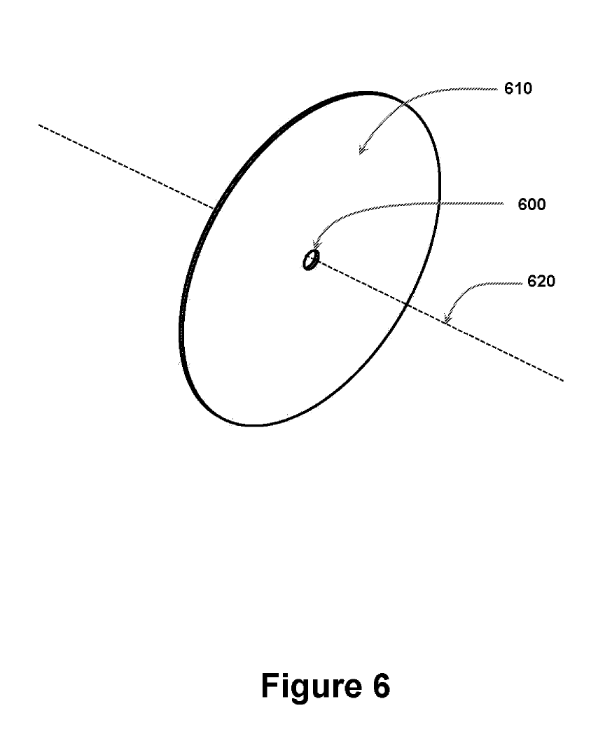

FIG. 6 illustrates an exemplary torque-resisting disk 610, in accordance with an embodiment of the present invention. In the present embodiment, torque-resisting disk, or torque disk 610 can be used to augment the compression and frictional forces generated by tightening the end caps of a link assembly. Torque disk provides a means for increasing rotational resistance between adjacent link plates. Torque disk 610 is positioned between link plates in a link assembly. For example, without limitation, torque disks 110 are shown between link plates 100 and 102 in FIG. 1. In the present embodiment, torque disk 610 comprises a hole 600 around the center of an axis of rotation 620 into which a connecting rod may be placed. Torque disks may use a variety of materials and mechanisms to aid in preventing the rotation of adjacent link assemblies. For example, without limitation, torque disks may be made of various types of materials with varying frictional properties including, but not limited to, plastic, metal, wood, rubber, rough sandpaper type material, etc. In some embodiments, torque disks may also comprise rough, grooved, spiked, or bumped surfaces to lock into adjoining link plates.

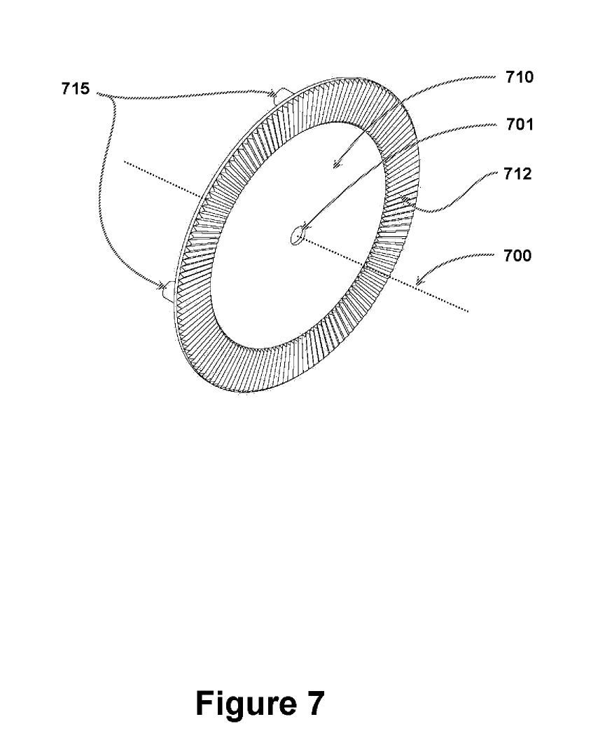

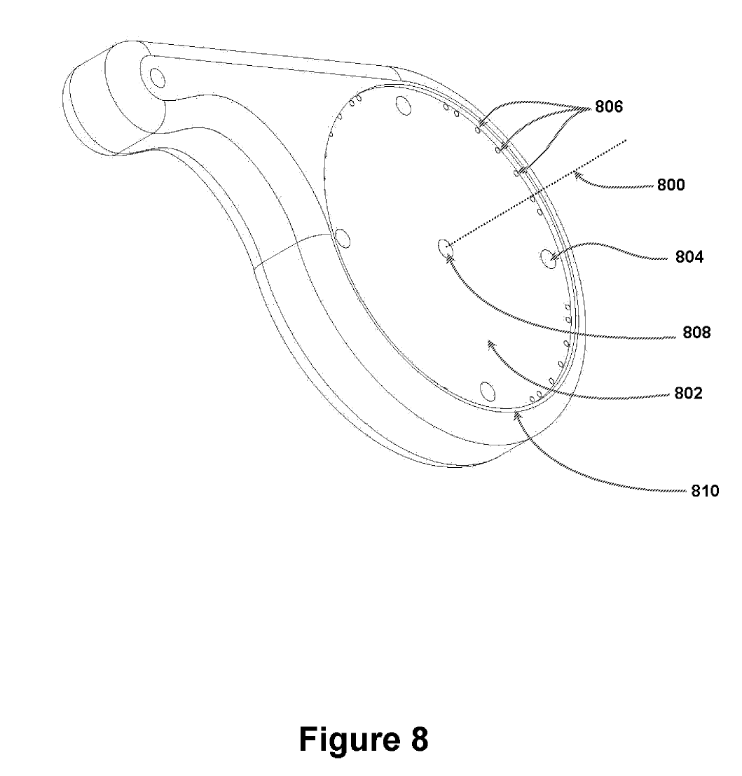

FIG. 7 illustrates an exemplary torque disk 710 with radial ridges 712, in accordance with an embodiment of the present invention. In the present embodiment, torque disk 710 comprises a central axis hole 701 around an axis of rotation 700, radial ridges or grooves 712 on a front side of torque disk 710, and nubs 715 on a back side of torque disk 710. Radial ridges 712 interlock with an identical adjacent torque disk or an adjacent link plate with ridges to resist rotation. Nubs 715 on the back of torque disk 710 fit into corresponding holes in an adjacent link plate, for example, without limitation, a link plate 804 shown by way of example in FIG. 8, when central axis hole 701 is aligned with the central axis hole of the link plate. In an alternate embodiment, the torque disk may not include nubs for interlocking with a link plate. In this embodiment the torque disk is held against the link plate with friction. In an alternate embodiment, the torque disk may not be round but a polygonal shape and fit into a corresponding shaped recess and be held in place like a large nut in a recessed opening. This polygonal ridged link plate may or may not have the additional nubs on the back side. In another alternate embodiment, a torque disk with grooved radial ridges may also be incorporated and manufactured into a link plate and made as one piece if the material, manufacturing process and cost permit.

Sheer Method

The frictional force method of torque resistance with torque disks described previously may be further augmented or replaced by a sheer force resistance method to provide another means for increasing rotational resistance between adjacent link plates. FIG. 8 illustrates an exemplary link plate 802 with sheer holes 806, in accordance with an embodiment of the present invention. In the present embodiment, link plate 802 comprises sheer holes 806 disposed around a central axis of rotation 800. Metal rods or pins are placed through sheer holes 806. These metal rods or pins penetrate multiple adjacent link plates parallel to central axis of rotation 800. The sheer force exerted on the metal pins between the adjoining link plates causes the joint to become immobile and resistant to significant rotational forces. Alternate embodiments may use means other than metal rods or pins to resist rotational force such as, but not limited to wooden or plastic pegs. In the present embodiment link plate 802 also comprises a circular recessed portion 810 into which a torque disk may fit. Link plate 802 also comprises holes 804 that correspond to nubs on a torque disk into which the nubs of the torque disk may be inserted to hold the torque disk in place. Alternate embodiments may not include a recessed portion or holes for nubs on a torque disk. The sheer method may provide additional torque resistance to friction methods previously described for example, without limitation, the grooved torque disk method as an augmentation, or this method may be used as an alternative to the friction methods. The sheer method of resisting rotation may be able to resist the torque forces more effectively than friction methods; however, this method may also have a more limited number of adjustment angles as compared to friction methods.

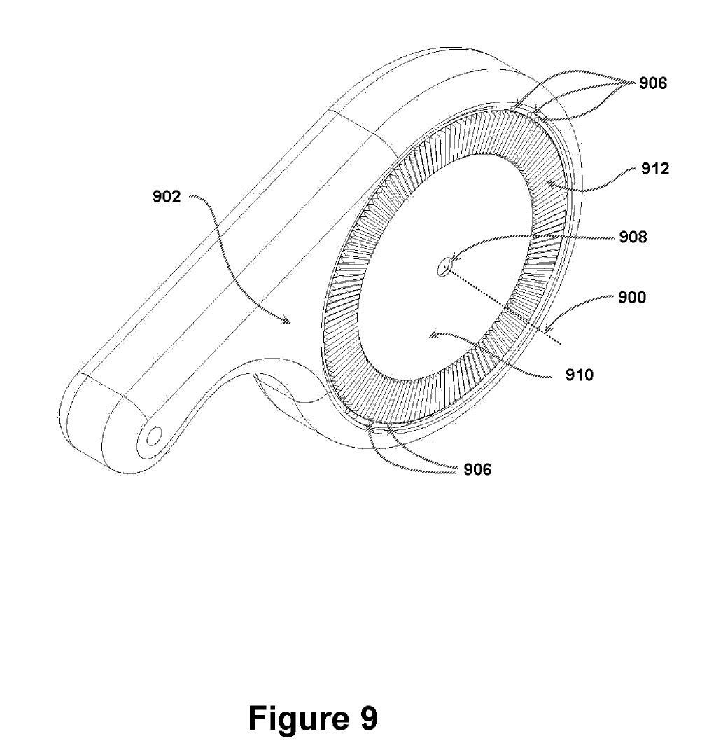

FIG. 9 illustrates an exemplary link plate 902 with sheer holes 906 and a torque disk 910 with radial ridges 912, in accordance with an embodiment of the present invention. In the present embodiment link plate 902 and torque disk 910 share a central axis of rotation 908. Sheer holes 906 enable link plate 902 to resist rotation in relation to adjoining link plates using the sheer method previously described with pins or rods inserted into sheer holes 906, and radial ridges 912 on torque disk 910 further enable link plate 902 to resist rotation using the friction method previously described. The link plate 902 may also be combined and manufactured with and integrated torque disk 912 into a single piece. to provide another means for increasing rotational resistance between adjacent link plates.

Additional Component Descriptions

Perpendicular Joint Assemblies—

FIG. 10 illustrates an exemplary multi-axis joint assembly with two axes of rotation 1002 and 1010, in accordance with an embodiment of the present invention. In the present embodiment the joint assembly facilitates joining link assemblies together at a ninety-degree or perpendicular offset with respect to axes of rotation 1002 and 1010. The joint assembly comprises a link assembly comprising multiple round link plates 1000 along a common central axis of rotation 1002 connected to an adjoining link assembly comprising a set of round link plates 1008 along a common axis of rotation 1010. In the present embodiment, axis of rotation 1002 is perpendicular to axis of rotation 1010. In alternate embodiments, the sets of link plates may be at various other angles to each other to create structures with angles other than ninety degrees such as, but not limited to, fifteen degrees, thirty degrees, forty-five degrees, sixty degrees, etc. Connecting rods 1004 run trough holes 1006 in adjoining link plates 1000 and 1008 and may be fastened by glue or mechanical methods to link plates 1000 and 1008. Connecting rods 1004 provide a means for joining the two link assemblies. In some embodiments, connecting rods 1004 may be held in place by friction alone. In another alternate embodiment, the connecting rods may be an integral part of the link plates and not a separate piece of material.

Connecting rods (not visible) run through holes around axes of rotation 1002 and 1010 with end caps 1012 on each end of the connecting rods to hold the link assemblies together and to possibly stop unwanted rotation about axes of rotation 1002 and 1010. Depending on the amount of torque the joint assembly is meant to withstand, it may be necessary to use some type of torque-resisting disk (not visible) between the adjoining faces of link plates 1000 and 1008 to resist any undesired rotation of adjoining link plates and link plates 1000 and 1008 about axes of rotation 1002 and 1010. Alternate means for resisting rotation about axes of rotation 1002 and 1010 may be used in various embodiments such as, but not limited to, various different types of torque disks, rods or pins in sheer holes, adhesives, etc.

Multi Axis Joint Assemblies—

FIGS. 11a through 11f illustrate exemplary perpendicular joint assemblies, in accordance with an embodiment of the present invention. FIGS. 11a and 11b show multi-axis joint assemblies 1101 and 1103 each with two axes of rotation and one link joint around a central axis 1100. FIG. 11c shows a multi axis joint assembly 1105 with two axes of rotation and two link joints around a central axis 1100. FIG. 11d shows a multi axis joint assembly 1107 with two axes of rotation and three link joints around a central axis 1100. FIG. 11e shows a multi axis joint assembly 1109 with two axes of rotation and four link joints around a central axis 1100. FIG. 11f shows a multi axis joint assembly 1111 with two axes of rotation and six link joints around a central axis 1100. Referring to FIG. 11a and FIG. 11b, multi axis joint assemblies 1101 and 1103 each comprise one link assembly attached around central axis 1100, which is perpendicular to the radially distributed holes along axes of rotation 1104 about which the link assemblies are attached. These joints can be made to accommodate two, three, four, five, six, or more link assemblies joined radially around a central axis 1100. Referring to FIG. 11c, multi axis joint assembly 1105 has the capacity for adjoining two link assemblies around central axis 1100. Referring to FIG. 11d, multi axis joint assembly 1107 has the capacity for adjoining three link assemblies around a central axis 1100. Referring to FIG. 11e, multi axis joint assembly 1109 has the capacity for adjoining four link assemblies around central axis 1100. Referring to FIG. 11f, multi axis joint assembly 1111 has the capacity for adjoining up to six link assemblies around central axis 1100. The multi axis link joints shown in FIGS. 11a through 11f each comprise a central set of link plates at central axis 1000; however, alternate embodiments may comprise a solid element at the central axis rather than an assembly of multiple link plates.

The multi axis joint assemblies illustrated by way of example in FIGS. 11a through 11f each have two axes of rotation. However, those skilled in the art, in light of the present teachings, will readily recognize that multi axis joint assembles in alternate embodiments may comprise more than two axis of rotation. For example, without limitation, in one embodiment a multi axis joint assembly comprises six link joints around a central axis, similarly to multi axis joint assembly 1111 shown by way of example in FIG. 11f. However, in this embodiment four of the link joints around the central axis may be perpendicular to the central axis and the remaining two joint assemblies may be at a fifteen-degree angle to the central axis. This embodiment may be particularly useful, for example, without limitation, to create a chair with four legs extending down from the four perpendicular joint assemblies and a chair back extending up from the fifteen-degree joint assemblies.

Additional Components—

In preferred embodiments, components may be added to link plate structures and link assemblies for special purposes such as, but not limited to, providing work surfaces, sitting surfaces, storage areas, etc. These components may include, without limitation, flat surfaces, link tubes, surface sleeves, storage pods, cushions, extended rods, drawers, wheels, baskets, fasteners, hooks for hanging, and mounting plates. etc. FIGS. 12 through 19 illustrate exemplary implementations of additional components in use with link plate structures and link assemblies to produce various types of furniture and structures.

For example, without limitation, flat surfaces can be placed on or attached to link plates to create work or storage surfaces. The flat surfaces rest on the link plates and may be held with only the force of gravity or the flat surfaces may be attached to the link plates using standard fasteners such as, but not limited to, screws bolts, pins, nails, etc. The flat surfaces are generally made of glass to enable the unique structural system to be visible thought the surface. However the flat surface may be made of other materials including, but not limited to, wood, metal or plastic.

Table—Incorporating a Multi Axis Joint Assembly and a Flat Surface

FIG. 12 illustrates an exemplary table assembled using a biomorphic furniture system, in accordance with an embodiment of the present invention. In the present embodiment, a flat surface 1250 made of glass acts as a tabletop. Flat surface 1250 rests on a central multi axis joint assembly 1240 with six link assemblies disposed around a central axis 1200 that act as legs 1201 through 1206. Each leg is attached to central multi axis joint assembly 1240 with the central axis of rotation of multi axis joint assembly 1240 corresponding to central axis 1200.

Each leg 1201 through 1206 comprises three sections of link assemblies. A first section comprises two link plates 1211 on either side of a second section comprising a single link plate 1212 that shares a common axis of rotation 1221 with link plates 1211. A third section comprises two link plates 1213 on either side of link plate 1212 with link plates 1212 and 1213 sharing a common axis of rotation 1222 on the opposite end of link plate 1212 from axis of rotation 1221. The third section is in turn connected to one of six ends 1241 of central multi axis joint assembly 1240.

A connecting rod (not visible) is placed through each hole along axes of rotation 1221, 1222 and 1223, and end caps 1231, 1232 and 1233 are attached to either side of the connecting rods. End caps 1231, 1232 and 1233 can be tightened along axes of rotation 1221, 1222 and 1223 to secure the joints in place. In the present embodiment, leg assemblies 1201 through 1206 are all created in the preceding manner. In this process of creating link assemblies with multiple sections, a link assembly typically has either one less or one more link plate than the adjacent link assembly has. This process may be repeated in various applications for example, without limitation, to make longer or shorter articulated finger and leg members.

Optionally torque-resisting disks may be placed between some or all of the adjacent link plates along axes of rotation 1221, 1222 and 1223. These torque-resisting disks augment the frictional forces holding the joints and enable the joints to resist more rotational forces and be more secure along axes of rotation 1221, 1222 and 1223. By loosening end caps 1231, 1232 and 1233, the link assemblies may be adjusted and therefore the individual characteristics of each leg 1201 through 1206 may be adjusted as well. This also enables legs 1200 through 1206 to be adjusted to a variety of height and width configurations for various table surfaces and uses. For example, without limitation, legs 1201 through 1206 may be widened, bringing multi axis joint assembly 1240 closer to the floor to create a coffee table. Furthermore, tables in alternate embodiments may comprise various different numbers of legs.

In the present embodiment, flat surface 1250 may be placed on either side of legs 1201 through 1206, to form a table. In the non-limiting example shown in FIG. 12, legs 1201 through 1206 face down with flat surface 1250 resting on multi-axis joint assembly 1240. In another non-limiting example, legs 1201 through 1206 may face upward with flat surface 1250 resting on the first sections of the legs 1201 through 1206 with multi axis joint assembly 1240 resting on the floor. In the present embodiment, flat surface 1250 is glass to enable the structure of the table to be visible. In alternate embodiments the table surface may be any suitable material such as, but not limited to, plastic, acrylic, wood, metal, etc. However, a clear surface is often preferred.

Seating surfaces may be provided in a variety of ways including, without limitation a fabric or leather sleeve that fits around link tubes or a stack of link plates. This fabric can provide a taut surface for sitting and for mounting or placing pillows. These seating sleeves may be made of various types of material including, but not limited to, fabric, leather, wicker, plastic, metal, wood, rubber, net, rope, etc. In some embodiments the sleeves may also incorporate a release mechanism such as, but not limited to, a zipper, snaps, buttons, or Velcro that enables the sleeves to be removed without disassembling the furniture. In some embodiments, sleeves may also include foam or cushioning.

Link tubes may be used in some embodiments to widen a piece of furniture or a structure. Since link tubes can extend a wider distance than standard width link plates, link tubes provide a more efficient use of materials in comparison to using many link plates stacked together. Link tubes may be any length. However, link tubes are generally in lengths that are multiples of the standard depth of the corresponding link plates. For example, without limitation, if a link plate standard depth is one-inch, the link tubes may be available in two, four, eight, sixteen, and thirty two-inch lengths. In this way the link tubes can be combined with the link plates to cover a variety of distances. The link tubes may be solid or hollow and may be made of a variety of materials including, but not limited to, wood, metal or plastic. In some embodiments the link tubes may be the same shape as the link plates that they are connecting, and in other embodiments the link tubes may be shaped differently for example, without limitation as cylinders or square tubes.

Lounge Chair

FIGS. 13a through 13d illustrate an exemplary lounge chair assembled using a biomorphic furniture system, in accordance with an embodiment of the present invention. FIG. 13a illustrates exemplary surface sleeves 1320. FIG. 13b illustrates an exemplary chair frame. FIG. 13 c illustrates the assembled chair in a horizontal position, and FIG. 13d illustrates the assembled chair in an upright position. In the present embodiment, the chair comprises link tubes 1310 as well as surface sleeves 1320.

The lounge chair is constructed of several link assembly sections. In the present embodiment, the chair comprises five link assemblies 1301 through 1305 for each side of the chair. Between link assemblies 1301 through 1305 on each side of the chair along axes of rotation 1300, three link tubes 1310 provide structure and separation between the two sides of the chair. The chair can easily be made wider or narrower by modifying the length of link tubes 1310. In the present embodiment, link tubes 1310 are cylindrical link plates that have been extended parallel to axes of rotation 1300. However, a multiplicity of suitable shapes for link tubes may be used in alternate embodiments.

The link plates that make up link assemblies 1301 through 1305 and link tubes 1310 are held in place by end caps 1315 attached to connecting rods (not visible) along axes of rotation 1300 similarly to the non-limiting examples previously shown. Torque disks or sheer rods may also be used between link plates as in previous examples.

The lounge chair also makes use of surface sleeves 1320. The seat and back surface of the chair are each composed of a surface sleeve 1320 that is slid around two adjacent link tubes 1310 and is drawn tight. This taught material of surface sleeves 1320, preferably fabric or leather, provides a surface on which to sit or lie down. In some embodiments, pillows may also be placed or strapped on top of surface sleeves 1320 to provide additional comfort.

This chair also demonstrates the some of the versatility of the design of preferred embodiments of the present invention. Using the same link assemblies 1301 through 1305 in a slightly different orientation transforms the upright chair shown by way of example in FIG. 13d to a more horizontal lounge chair with arms as shown by way of example in FIG. 13c. In addition, some of end caps 1315 may be quick release type end caps to enable a user to adjust the position of the back and or legs of the char more easily.

Desk Chair

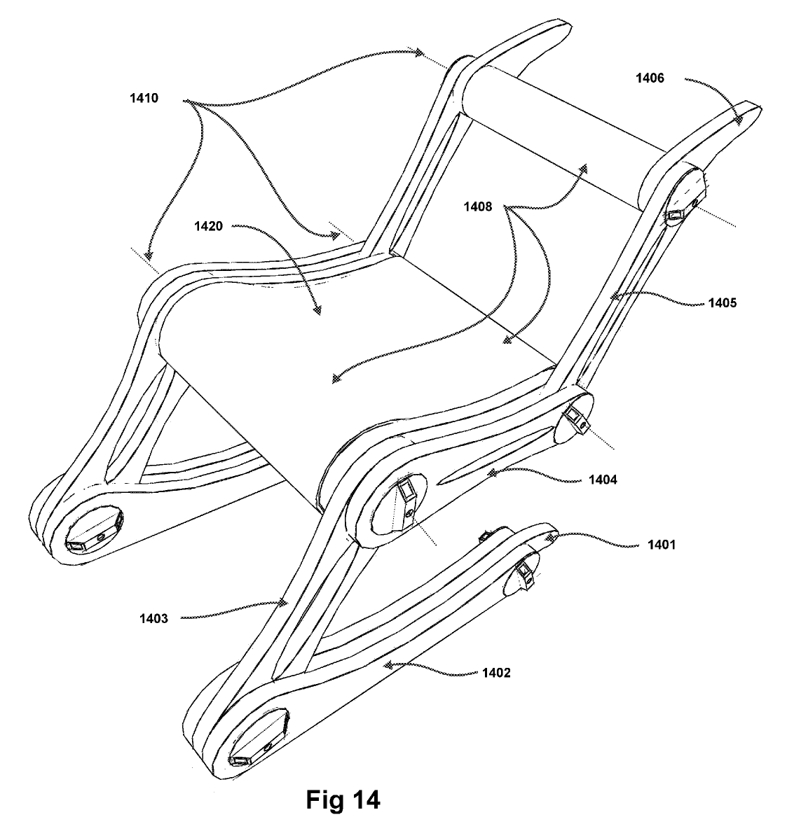

FIG. 14 illustrates an exemplary cantilevered chair assembled using a biomorphic furniture system, in accordance with an embodiment of the present invention. In the present embodiment, the chair comprises link plates, link tubes 1408 and a surface sleeve 1420. The chair comprises six sections of link assemblies 1401 through 1406 on each of the sides of the chair and three link tubes 1408 that span between link assemblies 1401 through 1406 along axes of rotation 1410. Link assemblies 1401 through 1406 are similar to previously described link assemblies in method of construction.

In the present embodiment, a surface sleeve 1420 is wrapped around the two link tubes 1410 that comprise the seat structure that acts as the seating surface. In the present embodiment, the link tube 1410 on the back of the chair is not covered with a surface sleeve; however, in alternate embodiments this back link tube may be covered in a surface sleeve, and in some embodiments, this surface sleeve may include padding to provide more comfort when leaning against the back link tube.

In the present embodiment, the joints between link assemblies 1401 through 1406 include torque resisting disks (not visible) to resist the large rotational forces associated with someone sitting in the chair. These disks are placed between the link plates and, when end caps are tightened along connecting rods along axes of rotation 1410, the torque resisting disks help to resist the rotational forces between the adjoining link assemblies. Alternate methods of resisting the rotational forces may be used in alternate embodiments including, without limitation, rods or pins in sheer holes, adhesives, etc. The joints in the present embodiment must be sufficiently secure to withstand the force of someone sitting in the chair.

Desk

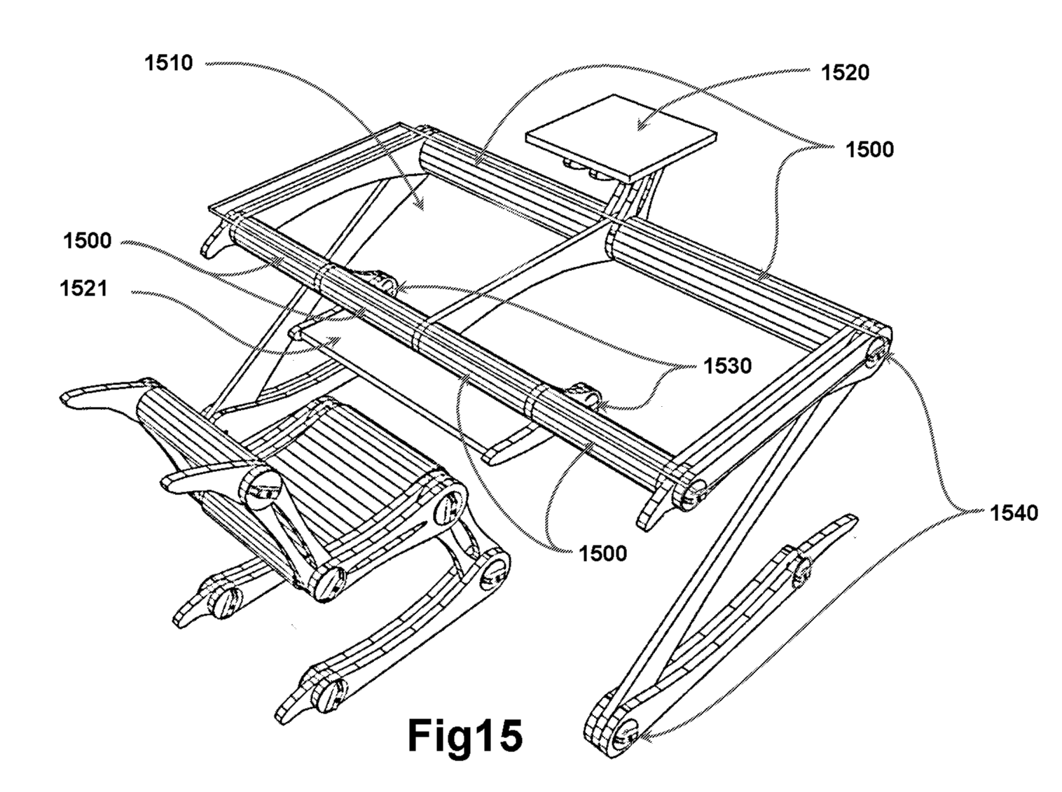

FIG. 15 illustrates an exemplary desk and chair assembled using a biomorphic furniture system, in accordance with an embodiment of the present invention. In the present embodiment, the desk comprises a flat top 1510, which is another example of a flat surface resting on link assemblies to provide a useful surface. Flat top 1510 is glass in the present embodiment; however, a multiplicity of suitable materials for desks tops may be used in alternate embodiments including, but not limited to, wood, plastic, metal, etc. In the present embodiment, the desk comprises multiple link assemblies that are connected together with link tubes 1500, an elevated flat surface in the middle to form a monitor stand 1520 and a lower flat surface to form a keyboard tray 1521. End caps 1330 on keyboard tray 1521 and monitor stand 1520 may be of the quick release type depending on how often the desk must be adjusted. The height and angle of the desk can also be adjusted by loosening end caps 1340 and adjusting the adjoining link assemblies. The chair is assembled similarly to the chair shown by way of example in FIG. 14. However, the surface sleeve in the present embodiment is made of mesh webbing rather than fabric or leather.

Humanoid Chair

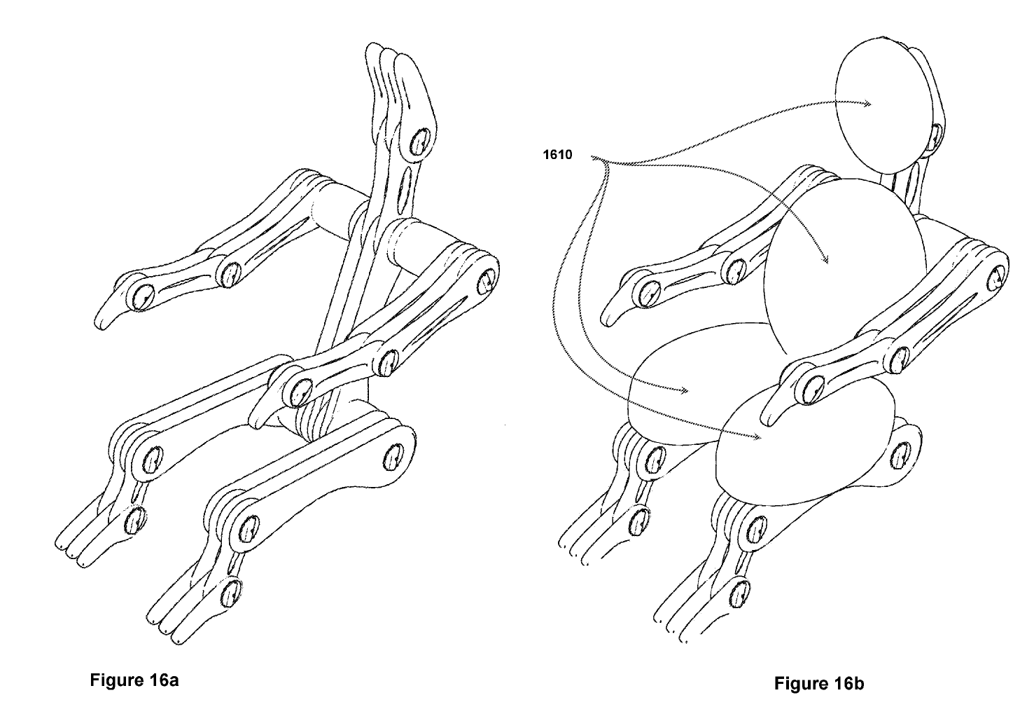

FIGS. 16a and 16b illustrate an exemplary chair configuration that has a humanoid form assembled using a biomorphic furniture system, in accordance with an embodiment of the present invention. FIG. 16a shows the chair structure without cushions, and FIG. 16b show the chair structure with cushions 1610. In the present embodiment, cushions 1610 are attached to the link assemblies that form the thighs, back and head of the chair. Cushions 1610 may be attached to the chair structure using various different means including, without limitation, straps, adhesive, snaps, Velcro, screws, etc.

Bed

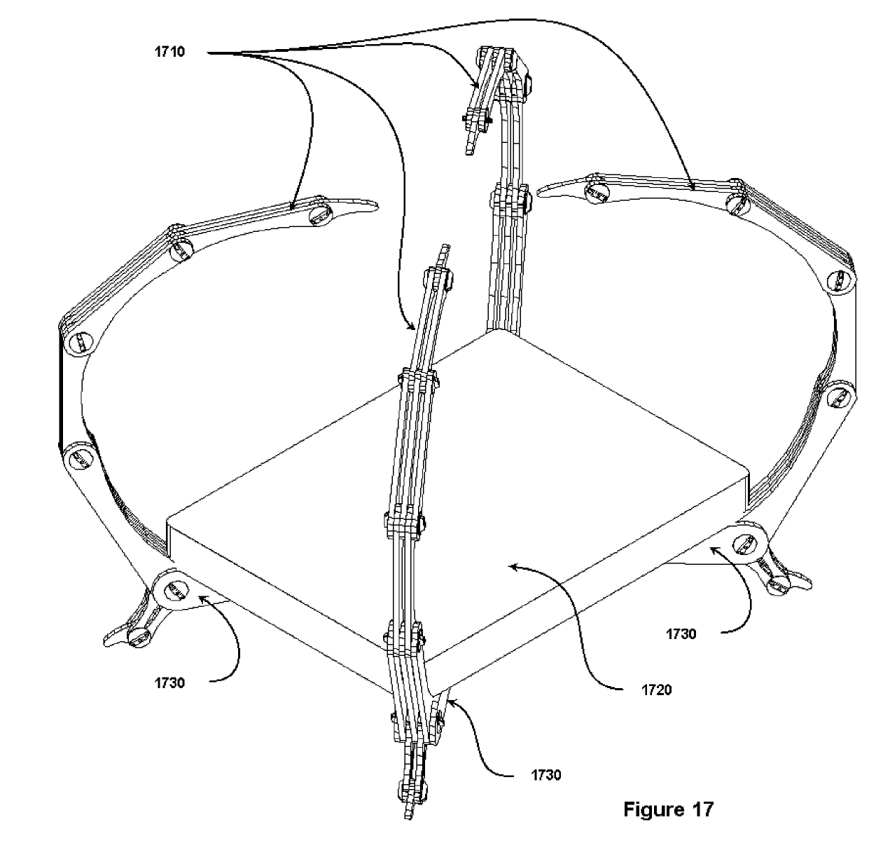

FIG. 17 illustrates an exemplary bed with four post type arms 1710 assembled using a biomorphic furniture system, in accordance with an embodiment of the present invention. In the present embodiment, posts or arms 1710 on the bed comprise multiple link assemblies that can be individually adjusted and shaped to fit the needs or whims of the user. A mattress 1720 rests on a base of the bed comprising crossing link plates 1730. Mattress 1720 may be supported by various means on the base of the bed such as, but not limited to, a platform, slats or a box spring (not visible) resting on or attached to crossing link plates 1730 forming the base of the bed.

Some embodiments of the present invention comprise storage pod units that are hollow and are intended to provide spaces for shelves, drawers, hanging items, etc. These units may also comprise means for modularity. Storage pod units may or may not incorporate features such as, but not limited to, doors, drawers, shelves or hanging rods to aid in the storage of items inside the storage pods. These storage pod units may be made of various types of material including, but not limited to, plastic, metal, wood, fabric, or a combination of such materials. Storage pod units may be available in a variety of forms and sizes to accommodate differing needs. For example, without limitation, a small storage pod unit may be provided for a nightstand as shown by way of example in FIGS. 18a and 18b, or a large, tall storage pod unit with doors and a top bar may be provided for an armoire as shown by way of example in FIG. 19, a long storage pod unit with drawers may be used as a dresser, or a small storage pod unit with drawers may act as a file drawer.

Nightstand—Incorporating a Storage Pod

FIGS. 18a and 18b illustrate an exemplary nightstand incorporating a storage pod unit 1820 assembled using a biomorphic furniture system, in accordance with an embodiment of the present invention. FIG. 18a illustrates the nightstand, and FIG. 18b illustrates storage pod unit 1820 separate from the nightstand. In the present embodiment, structural legs 1810 through 1813 are made up of multiple of link assemblies as previously described. Legs 1810 through 1813 may be individually adjusted and shaped to fit the needs or whims of the user. The nightstand also incorporates a flat glass surface to act as a table top 1815. In alternate embodiments the flat top surface may be made of materials other than glass such as, but not limited to, wood, plastic, or metal.

Referring to FIG. 18b, storage pod unit 1820 is shown at a smaller scale without link assembly legs 1810 through 1813 attached. Storage pod unit 1820 is generally hollow to enable a user to store items inside storage pod unit 1820. Storage pod unit 1820 may or may not comprise shelves or doors. In the present embodiment storage pod unit 1820 is shown with doors. Storage pod unit 1820 comprises two link plates 1830 that are attached to and protrude from a top surface of storage pod unit 1820 to provide a means for joining the storage pod unit to the link assembly. In alternate embodiments, storage pod units may comprise link plates in varying locations to enable link plate assemblies to be attached to the storage pod units in different configurations. For example, without limitation, a storage pod unit 1920, shown by way of example in FIG. 19, comprises link plates on a bottom surface so that legs may be attached to the bottom of storage pod unit 1920. In the present embodiment, link plates 1830 share a common axis of rotation 1832. Referring to FIG. 18a, the link assemblies of legs 1810 through 1813 attach to link plates 1830 to enable storage pod unit 1820 to stand on the floor. In the present embodiment, surface arm holders 1840 are connected along axis of rotation 1832 as well, and table top 1815 rests on surface arm holders 1840.

Armoire

FIG. 19 illustrates an exemplary armoire that comprises a storage pod unit 1920 assembled using a biomorphic furniture system, in accordance with an embodiment of the present invention. The armoire is similar to the nightstand shown by way of example in FIG. 18a; however, the armoire is larger than the nightstand. Furthermore, legs 1931 through 1934 of the armoire are attached to protruding link plates 1941 and 1942 at the bottom of storage pod unit 1920.

Storage pod units in alternate embodiments may be available in a variety of sizes, shapes and materials. A similarity of storage pod units in various embodiments is the attached and protruding link plates that enable link assemblies to connect to the storage pod units to create structures such as, but not limited to, legs, arms, feet, hooks, bars, and other appendages. Those skilled in the art, in light of the present teaching, will readily recognize that adaptations to the storage pod concept can create other furniture types and forms. Various other types of nightstands, dressers and armoires may be built using storage pod units that have a similar form and function to those illustrated by way of example in FIGS. 18a, 18b and 19 with different dimensions. For example, without limitation, a dresser may incorporate a storage pod unit that is wider than storage pod unit 1820 is, yet the height and depth may be the same. In addition, storage pod units may be used to create furniture other than nightstands, dressers and armoires such as, but not limited to, media stands, desks, display cases, pantries, etc. Storage pod units may also comprise multiple sets of protruding link plates to enable link assemblies to be attached to the storage pod units in multiple locations or to enable a user to choose where to attach the link assemblies. Storage pod units may also be used upside down with the link assembly legs attached to the bottom of the storage pod units for a different effect. This is another non-limiting example of the flexibility and variety of forms and styles that can be achieved using the same modular parts in an almost limitless combination of shapes styles and uses with preferred embodiments of the present invention.

The exemplary furniture pieces illustrated in FIGS. 12 through 19 are non-limiting examples of some of the types of structures that may be assembled using biomorphic furniture systems according to preferred embodiments of the present invention. Those skilled in the art, in light of the present teachings, will readily recognize that numerous other types of furniture may be assembled using preferred embodiments of the present invention including without limitation, benches, bookshelves, armchairs, dining room tables, etc. Furthermore, biomorphic furniture systems according to preferred embodiments need not be confined to furniture uses. For example, without limitation, a system may be expanded to make other forms such as, but not limited to, outdoor gazebos, play structures, sculptures, picture frames, wall shelves, etc. In one embodiment, a biomorphic system of modular components may be scaled down to become a child's toy.

Humanoid

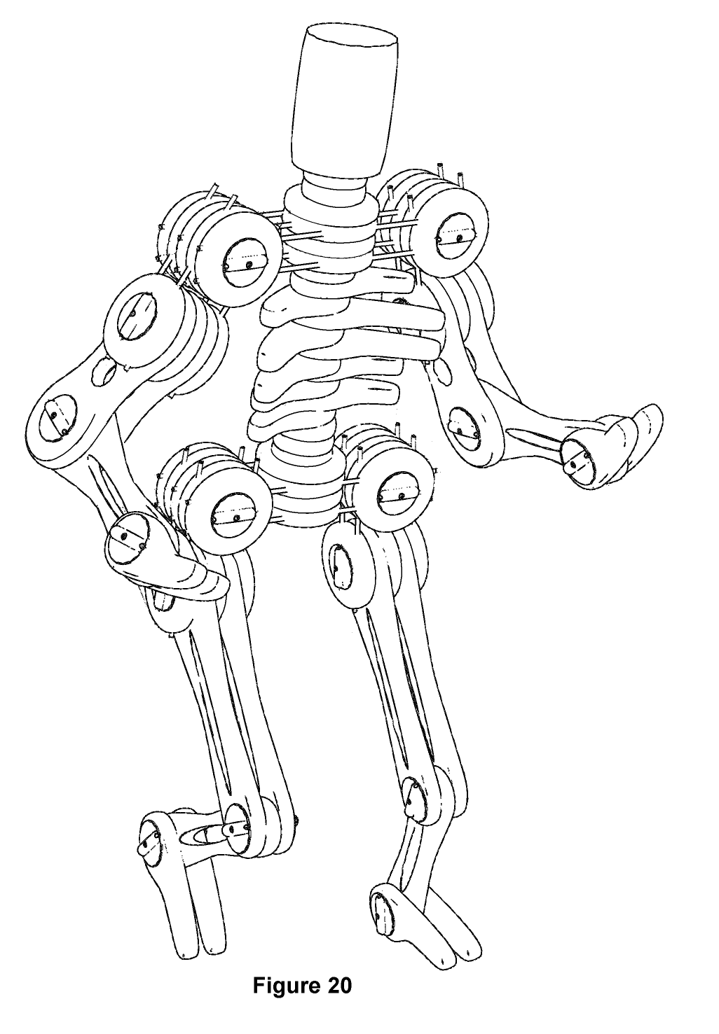

FIG. 20 illustrates an exemplary humanoid figure assembled using a biomorphic furniture system, in accordance with an embodiment of the present invention. This is an yet another example of the extensive possibilities that can be easily achieved by putting the simple link plates and assemblies together in new and unique forms and uses. This assembly may not have a typical furniture function; however the assembly illustrates an alternative use of embodiments of the present invention to create decorative structures that accents a set of furniture. Additionally, this assembly can be reconfigured, in accordance with the teaching herein, to chair, similar to FIG. 16, or other piece of furniture. Furthermore, the assembly pays homage to probably the most amazing and wonderful forms in the world, the human body.

### CONCLUSION

The unique look, the design flexibility and the ease of manufacture, shipping and repair make preferred embodiments of the present invention an effective solution to the dynamic demands placed on furniture in today's rapidly changing world. Biomorphic furniture systems according to preferred embodiments are versatile with a nearly infinite array of possible furniture forms and uses. This while using a limited number of inexpensive modular parts. These systems also have a unique modern yet natural design style. Preferred embodiments pay homage to and find inspiration from beautiful forms found in human bodies and in nature.

It is envisioned that the furniture will be sold in sets with the correct number and type of components and an instruction booklet in preferred embodiments. The end consumer would then be responsible for assembling the furniture according to the instructions. Furthermore multiple sets or combinations of sets may be available that have a variety of instructions for varying configurations included or available for download. In addition, a user may choose to combine two or more sets of furniture or add specially ordered pieces to make a completely new set with an entirely different use. For example, without limitation, if a user currently owns a table and three chairs, and now needs a queen bed, the user can order two long link plates for the base of the bed and reuse the pieces from the table and chairs to create the arms and legs of the new bed.

It is also envisioned that the furniture sets according to preferred embodiments can be taken apart for easy shipping and compact storage. This would greatly reduce the expense of shipping furniture because the furniture will be significantly smaller in size. It is contemplated that the disassembled furniture would occupy one-sixth to one-half the amount of space that traditional monolithic furniture forms typically occupy. Moreover, this will reduce the amount of warehouse space and expanse needed for storage. This would also benefit the end user for example, without limitation, if the furniture must be moved or stored. In addition, broken furniture components can easily and inexpensively be replaced by the end user. Preferred embodiments do not necessitate the difficult process of fixing many of today's large monolithic furniture pieces. A user can simply order a new replacement part and replace the broken part himself.

It is also envisioned that furniture systems according to preferred embodiments could be more easily sold online than traditional furniture. Traditional furniture has several limiting factors for being sold online, the most notable being the size and shipping costs associated with the monolithic furniture components. A modular biomorphic furniture system could more easily be shipped. Additional or replacement components could also be ordered and added to expand or modify the furniture form or function. Furthermore, various configuration instructions may be added to a website for users to download.

Having fully described at least one embodiment of the present invention, other equivalent or alternative methods of providing a modular furniture system according to the present invention will be apparent to those skilled in the art. The invention has been described above by way of illustration, and the specific embodiments disclosed are not intended to limit the invention to the particular forms disclosed. For example, the particular implementation of the furniture system may vary depending upon the particular type of link plates used. The link plates described in the foregoing were directed to biomorphic implementations; however, similar techniques are to provide link plates in various shapes such as, but not limited to, curved shapes, linear shapes, geometric shapes, irregular shapes etc. to create modular furniture systems that are based on forms other than those found in the human body or in nature. For example, without limitation, a linear modular furniture system may comprise link plates with square and rectangular shapes. Non-biomorphic implementations of the present invention are contemplated as within the scope of the present invention. The invention is thus to cover all modifications, equivalents, and alternatives falling within the spirit and scope of the following claims.

What is claimed is:

1. An apparatus for reconfigurable furniture, the apparatus comprising:
a link assembly comprising:
a plurality of link plates each comprising at least two parallel flat surfaces and at least one hole extending through said flat surfaces;
a connecting rod extending through holes on said flat surfaces providing an axis of rotation for said link plates; and
two end caps joined to ends of said connecting rod where said end caps are operable to create a tension force along said connecting rod to provide a degree of rotational resistance between flat surfaces of said link plates; and
means for joining at least two link assemblies, wherein positions of said link plates are reconfigurable to form the furniture.

2. The apparatus as recited in claim 1, further comprising at least one torque disk comprising a central hole and, said torque disk being positioned on said connecting rod to further provide rotational resistance.

3. The apparatus as recited in claim 2, wherein said torque disk further comprises at least one surface comprising frictional properties to provide rotational resistance.

4. The apparatus as recited in claim 3, wherein said frictional properties comprises radial ridges.

5. The apparatus as recited in claim 2, wherein said torque disk further comprises nubs to engage corresponding holes on a one of said link plates.

6. The apparatus as recited in claim 1, wherein at least one of said end caps comprises a quick release mechanism for engaging and releasing said tension force.

7. The apparatus as recited in claim 1, wherein at least two of said link plates comprises a plurality sheer holes in said flat surfaces and the apparatus further comprises a pin or rod inserted between adjacent sheer holes of said at least two link plates.

8. The apparatus as recited in claim 1, further comprising a link tube positioned between adjacent link plates.

9. The apparatus as recited in claim 8, further comprising a surface sleeve covering said link tube.

10. The apparatus as recited in claim 1, further comprising a storage pod joinable between adjacent link plates.

11. The apparatus as recited in claim 1, wherein a plurality link assemblies are joined with a flat surface to be configured as a table.

12. An apparatus for reconfigurable furniture, the apparatus comprising:
a link assembly comprising:
means for joining a plurality of link plates on an axis of rotation for said link plates; and
means for creating a tension force along said means for joining a plurality of link plates to provide a degree of rotational resistance said link plates; and
means for joining at least two link assemblies, wherein positions of said link plates are reconfigurable.

13. The apparatus as recited in claim 12, further comprising means for increasing rotational resistance between adjacent link plates.

14. The apparatus as recited in claim 12, further comprising means for joining a storage unit.

15. A method for reconfiguring furniture comprising steps for:
joining a plurality of link plates on a plurality of connecting rods;
joining end caps to ends of said connecting rods to provide a degree of rotational resistance between said link plates and form link assemblies; and
joining said link assemblies in a reconfigurable manner to form the furniture.

16. The method as recited in claim 15, further comprising a step of joining at least one torque disk on at least one connecting rod to further provide rotational resistance.

17. The method as recited in claim 15, further comprising a step of joining a link tube to one of said link assemblies.

18. The method as recited in claim 17, further comprising a step of joining a surface sleeve to said link tube.

19. The method as recited in claim 15, further comprising a step of joining a storage pod to one of said link assemblies.

20. The method as recited in claim 15, further comprising a step of joining a flat surface to said link assemblies.
